(19) United States
(12) Patent Application Publication
(10) Pub. No.: US 2011/0151920 A1
(43) Pub. Date: Jun. 23, 2011

(54) HANDOVER CONTROLLING METHOD AND APPARATUS

(75) Inventors: Sang Chul OH, Daejeon (KR); Seung-Que LEE, Daejeon (KR); Hyung Deug BAE, Daejeon (KR); Jun Sik KIM, Daejeon (KR); Nam Hoon PARK, Daejeon (KR)

(73) Assignee: Electronics and Telecommunications Research Institute, Daejeon (KR)

(21) Appl. No.: 12/849,240

(22) Filed: Aug. 3, 2010

(30) Foreign Application Priority Data
Dec. 21, 2009 (KR) 10-2009-0127909

(51) Int. Cl. H04W 36/00; H04B 7/00

(52) U.S. Cl. 455/525

(57) ABSTRACT

A method for controlling a handover from a source base station to a target base station determines whether a direct interface connecting the source base station and the target base station exists, compares a link latency of the direct interface with a link latency of an indirect interface connecting the source base station and the target base station when it is determined that the direct interface exists, and selects a handover execution interface, between the direct interface and the indirect interface, based on the comparison result.

### CROSS-REFERENCE(S) TO RELATED APPLICATION(S)

The present invention claims priority of Korean Patent Application No. 10-2009-0127909, filed on Dec. 21, 2009, which is incorporated herein by reference.

### FIELD OF THE INVENTION

The present invention relates to a method and apparatus for controlling a handover from a source base station to a target base station. In particular, the present invention relates to a method and apparatus for controlling a handover between an X2 interface and an S1 interface, by comparing link latencies of the X2 interface and the S1 interface.

### BACKGROUND OF THE INVENTION

In a cell-based radio communications system, a service area is divided into a plurality of coverages that are commonly called cells. The respective cells are serviced from a plurality of base stations. A handoff or handover (HO) refers to a processing scheme that transfers a call of a user equipment (UE) from one cell to another in order to maintain a radio connection between the UE and a network.

A basic form of the handoff or handover may be that a moving UE is redirected from its current cell (e.g., a source cell) and channel to a new cell (e.g., a target cell) and channel.

A basic form of the handoff or handover may be that a moving UE is redirected from its current cell (e.g., a source cell) and channel to a new cell (e.g., a target cell) and channel. In a terrestrial network, the UE may be served from two different cells or from two different sectors on a same cell. The former case is referred to as an inter-cell handover, and the latter case is referred to as an intra-cell handover (e.g., a handover within a single sector or a handover between different sectors on a same cell. In general, the purpose of the inter-cell handover is to maintain a call when a UE is moving out of an area covered by a source cell and entering an area of a target cell.

For example, in an Evolved-Universal Terrestrial Radio Access Network (E-UTRAN) architecture, an interface between two Evolved Node-Bs (eNBs) (or base stations) is referred to as an X2 interface, and an interface between two eNBs via an Evolved Packet Core (EPC) is referred to as an S1 interface.

That is, the X2 interface refers to an interface that directly connects two eNBs, and the S1 interface refers to an interface that indirectly connects the eNBs via a Mobility Management Entity (MME) and/or a Serving-GateWay (S-GW). If a UE is located in a handover area belonging to both a first cell area serviced by a first eNB and a second cell area serviced by a second eNB and the UE moves from the first cell area to the second cell area, the first eNB operates as a source eNB and the second eNB operates as a target eNB.

Generally, a handover related to 3rd Generation Partnership Project Long Term Evolution (3GPP LTE) and a handover related to LTE-Advanced support both an inter-eNB handover and an inter-Radio Access Technology (RAT) handover. The inter-eNB handover is executed through the X2 interface, except for a case in which no X2 interface exists between a source eNB and a target eNB.

In certain situations, however, even though the X2 interface exists, a link latency of the X2 interface may be greater than a link latency of the S1 interface. In such a case, if the handover is chosen to be made through the X2 interface despite the greater link latency thereof, it may entail an undesirable increase in the handover execution time.

### SUMMARY OF THE INVENTION

Accordingly, it is the primary object of the present invention to provide a method and apparatus capable of executing a high-speed and efficient inter-eNB handover by way of selectively choosing a handover execution interface based on a comparison between a link latency of an X2 interface and a link latency of an S1 interface.

In accordance with one aspect of the present invention, there is provided a method for controlling a handover from a source base station to a target base station, the method including the steps of:

determining whether a direct interface directly connecting the source base station and the target base station exists;

comparing a link latency of the direct interface with a link latency of an indirect interface indirectly connecting the source base station and the target base station, when it is determined that the direct interface exists; and

selecting a handover execution interface, between the direct interface and the indirect interface, based on the comparison result.

In accordance with another aspect of the present invention, there is provided an apparatus for controlling a handover from a source base station to a target base station, the apparatus including:

a determination unit for determining whether a direct interface directly connecting the source base station and the target base station exists;

a comparison unit for comparing a link latency of the direct interface with a link latency of an indirect interface indirectly connecting the source base station and the target base station, when it is determined that the direct interface exists; and

a selection unit for selecting a handover execution interface between the direct interface and the indirect interface, based on the comparison result.

In accordance with the present invention, it is possible to minimize the handover execution time, even when the link latency of the X2 interface is increased due to, e.g., an abnormal situation in the X2 interface.

### BRIEF DESCRIPTION OF THE DRAWINGS

The above and other objects and features of the present invention will become apparent from the following description of embodiments given in conjunction with the accompanying drawings, in which:

FIG. 1 shows an Evolved-Universal Terrestrial Radio Access Network (E-UTRAN), which is applicable to the present invention;

FIG. 2 is a block diagram of a handover controlling apparatus in accordance with an embodiment of the present invention;

FIG. 3 is a detailed block diagram of the handover controlling apparatus shown in FIG. 2;

FIG. 4 is a flowchart illustrating a handover controlling method in accordance with an embodiment of the present invention; and

FIG. 5 is a flowchart illustrating a handover controlling method in accordance with another embodiment of the present invention.

### DETAILED DESCRIPTION OF THE EMBODIMENTS

Hereinafter, certain preferred embodiments of the present invention will be described in detail with reference to the accompanying drawings so that they can be readily implemented by those skilled in the art.

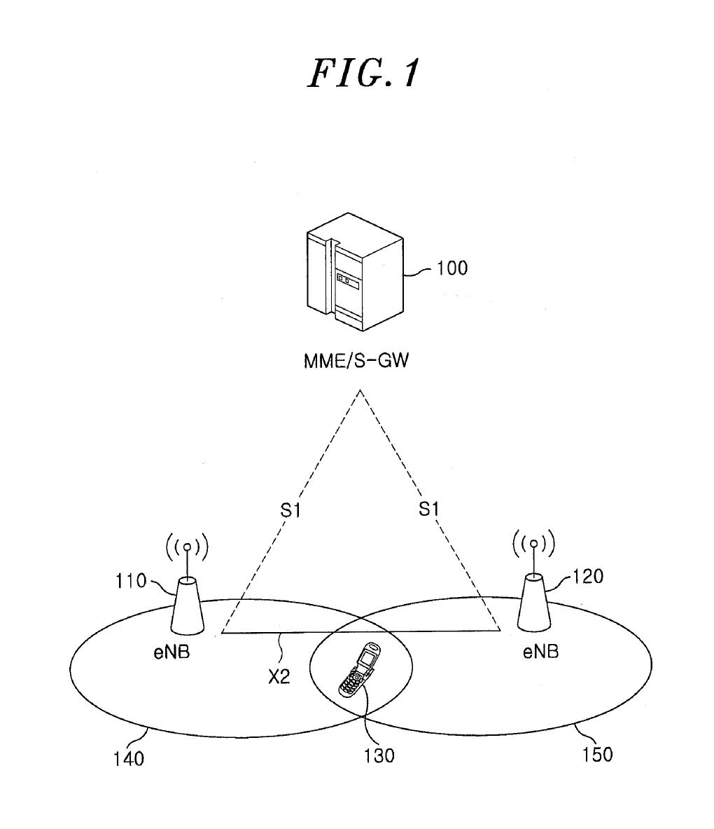

FIG. 1 shows an Evolved-Universal Terrestrial Radio Access Network (E-UTRAN) architecture, which is applicable to an embodiment of the present invention. Evolved Node-Base Stations (eNBs) 110 and 120 are connected through S1 interface links via an Evolved Packet Core (EPC) 100, which is an upper node. The EPC 100 may be a Mobility Management Entity (MME) and/or a Serving-GateWay (S-GW).

In the E-UTRAN architecture, as set forth above, an interface between eNBs 110 and 120 directly is referred to as an X2 interface, and an interface between eNBs 110 and 120 through the EPC 100 is referred to as an S1 interface. That is, the X2 interface refers to a direct interface that directly connects the eNBs, and the S1 interface refers to an indirect interface that indirectly connects the eNBs via an MME and/or a S-GW.

In FIG. 1, a user equipment (UE) 130 is located in a handover area belonging to both a cell area 140 serviced by the eNB 110 and a cell area 150 serviced by the eNB 120. When the UE 130 moves from the cell area 140 to the cell area 150, the eNB 110 operates as a source eNB and the eNB 120 operates as a target eNB. Generally, the inter-eNB handover is executed through the X2 interface, except for a case in which no X2 interface exists between the source eNB 110 and the target eNB 120. If, for instance, the source eNB 110 attempts a handover through the X2 interface but receives a negative acknowledgement from the target eNB 120, however, the handover may be executed through the S1 interface.

In a case where an abnormal situation occurs in the X2 interface between the source eNB 110 and the target eNB 120, the execution time of the handover using the X2 interface may increase as compared to that of the handover using the S1 interface. In such a case, the handover may be preferably executed through the S1 interface, to avoid an increased handover time caused by the abnormal situation in the X2 interface.

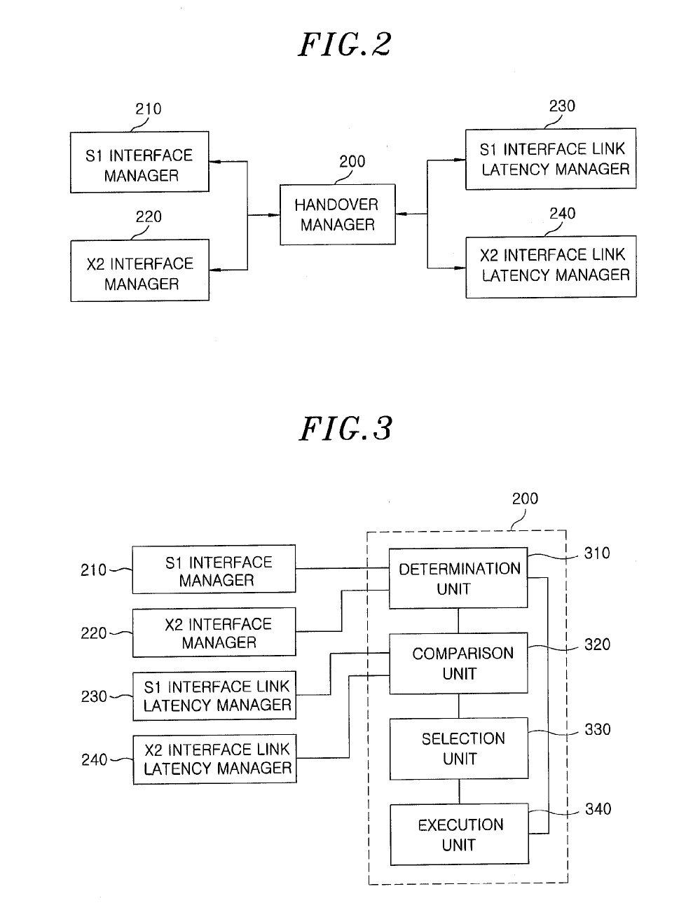

FIG. 2 is a block diagram of a handover controlling apparatus in accordance with an embodiment of the present invention.

The handover controlling apparatus includes a handover manager 200, an S1 interface manager 210, an X2 interface manager 220, an S1 interface link latency manager 230 and an X2 interface link latency manager 240.

The handover manager 200 is connected to the S1 interface manager 210, the X2 interface manager 220, the S1 interface link latency manager 320, and the X2 interface link latency manager 240. The handover manager 200 receives information about the S1 interface, the X2 interface, the S1 interface link latency, and the X2 interface link latency, and manages a handover procedure based on a comparison between the link latencies of the S1 and the X2 interfaces.

Although the S1 interface manager 210, the X2 interface manager 220, the S1 interface link latency manager 320, and the X2 interface link latency manager 240 are shown separately in FIG. 2, they may be integrated into the handover manager 200 to thereby function as a single device. In addition, the handover manager 200 may be incorporated in or independently separated from either eNB 110 or 120.

The S1 interface manager 210 functions to manage an S1 interface, and the X2 interface manager 220 functions to manage an X2 interface. Further, the S1 interface link latency manager 320 receives a latency value of the target eNB 120 from the EPC 100 (MME and/or S-GW) and manages the received link latency of the S1 interface. Similarly, the X2 interface link latency manager 240 receives and manages the link latency received from an X2 interface link which directly connects the source eNB 110 to the target eNB 120.

FIG. 3 is a detailed block diagram of the handover manager 200 shown in FIG. 2. In this embodiment, the handover manager 200 includes a determination unit 310, a comparison unit 320, a selection unit 330, and an execution unit 340.

The determination unit 310 is connected to the S1 interface manager 210 and the X2 interface manager 220 to receive information on the S1 interface and the X2 interface from the respective interface managers 210 and 220. Then, the determination unit 310 determines whether the X2 interface directly connecting the source eNB 110 and the target eNB 120 exists.

The comparison unit 320 is connected to the S1 interface link latency manager 230 and the X2 interface link latency manager 240 to receive the link latency value of the S1 interface and the link latency value of the X2 interface from the respective link latency managers 230 and 240, respectively. When it is determined by the determination unit 310 that the X2 interface exists, the comparison unit 320 compares the link latency of the X2 interface with the link latency of the S1 interface.

The selection unit 330 selects a handover execution interface between the X2 interface and the S1 interface, based on the comparison result from the comparison unit 320. The selection unit 330 selects the interface with a smaller latency as the handover execution interface. Also, when the link latency of the X2 interface is equal to the link latency of the S1 interface, the selection unit 330 selects the X2 interface as the handover execution interface.

The execution unit 340 executes the handover through the selected interface. That is, when the selection unit 330 selects the X2 (or S1) interface, the handover execution unit 340 executes the handover through the X2 (or S1) interface. Further, when the determination unit 310 determines that no X2 interface exists, the execution unit 340 executes the handover through the S1 interface. Furthermore, when the selection unit 330 selects the X2 interface but an error occurs upon the execution of the handover through the X2 interface, the execution unit 340 executes the handover through the S1 interface.

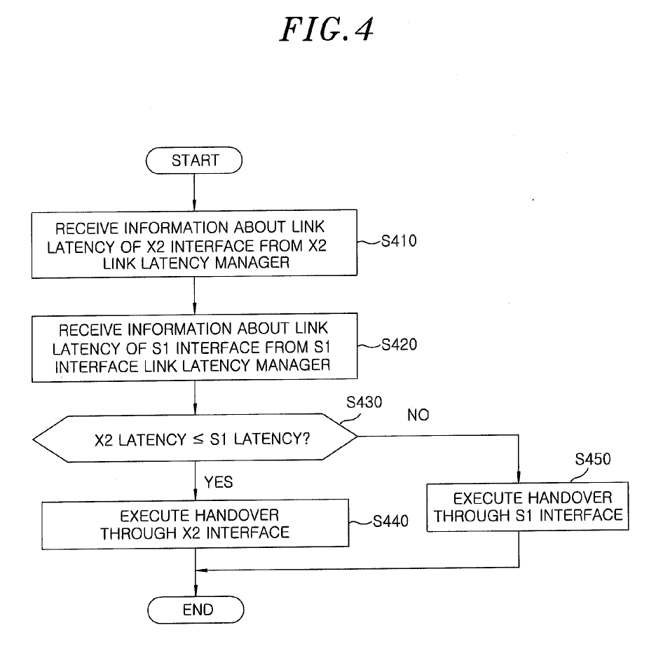

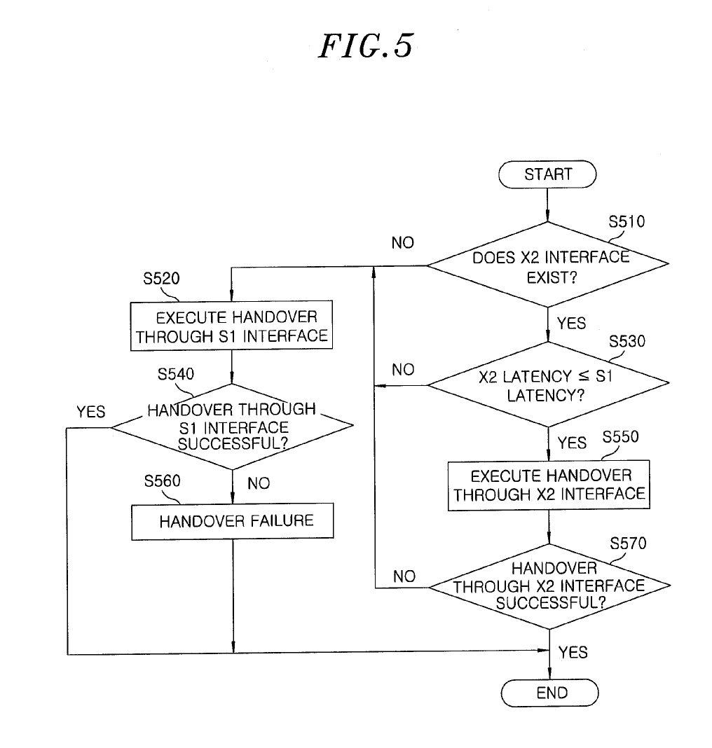

FIG. 4 is a flowchart illustrating a handover controlling method in accordance with an embodiment of the present invention wherein both the X2 interface and the S1 interface exist.

First, in step S410, the handover manager 200 receives information about the X2 link latency of the X2 interface (hereinafter referred to as an X2 link latency) connected to the target eNB 120 from the X2 interface link latency manager 240. Then, in step S420, the handover manager 200 receives the information about the link latency of the S1 interface (hereinafter referred to as an S1 link latency) connected to the MME and/or the S-GW from the S1 interface link latency manager 230. In some embodiments, the S1 link latency information may be received earlier than the X2 link latency information, or the S1 link latency information and the X2 link latency information may be received at the same time.

In step S430, the handover manager 200 compares the X2 link latency with the S1 link latency when both the S1 link latency and the X2 link latency are received. In some embodiments, the handover manager 200 may determine whether the X2 link latency is less than or equal to the S1 link latency. When the X2 latency is less than or equal to the S1 latency, the handover manager 200 instructs the execution of the handover through the X2 interface, in step S440. On the other hand, when the X2 latency is greater than the S1 latency, the handover manager 200 instructs the execution of handover through the S1 interface, in step S450.

FIG. 5 is a flowchart of the handover controlling method in accordance with another embodiment of the present invention.

When the handover from the source eNB 110 to the target eNB 120 is executed in step S510, it is determined whether the X2 interface directly connecting the source eNB 110 and the target eNB 120 exists. When the X2 interface exists, the method goes to step S530 where the link latency of the X2 interface is compared with the link latency of the S1 interface. When the X2 link latency is less than or equal to the S1 link latency, the method proceeds to step S550 where the X2 interface is selected and the handover is executed through the selected X2 interface.

Thereafter, in step S570, it is determined whether the handover through the X2 interface is successful. When it is determined that the handover through the X2 interface is not successful, the method advances to step S520 where the handover is executed through the S1 interface.

Furthermore, when the X2 link latency is greater than the S1 link latency in step S530, the handover is executed through the S1 interface as in step S520.

Subsequently, when the handover is executed through the S1 interface, it is determined in step 540 whether the handover through the S1 interface is successful. When it is determined that the handover through the S1 interface is not successful, a procedure for processing the handover failure may be performed in step S560. If, however, the handover through the S1 interface is determined successful, the method is ended.

The present invention provides a high-speed, efficient handover technology that selects an interface between the X2 interface and the S1 interface as the handover execution interface, by comparing the link latencies of the X2 interface and the S1 interface.

The modules, functional blocks or units set forth above may be implemented with a variety of known elements, such as electronic circuits, integrated circuits, and Application Specific Integrated Circuits (ASICs), alone or in combination with one or more elements.

While the invention has been shown and described with respect to the preferred embodiments, it will be understood by those skilled in the art that various changes and modifications may be made without departing from the scope of the invention as defined in the following claims.

What is claimed is:

1. A method for controlling a handover from a source base station to a target base station, the method comprising:
determining whether a direct interface directly connecting the source base station and the target base station exists;
comparing a link latency of the direct interface with a link latency of an indirect interface indirectly connecting the source base station and the target base station, when it is determined that the direct interface exists; and
selecting a handover execution interface, between the direct interface and the indirect interface, based on the comparison result.

2. The method of claim 1, wherein the indirect interface is an interface which passes through a Mobility Management Entity (MME) and/or a Serving-GateWay (S-GW).

3. The method of claim 1, wherein said selecting the handover execution interface includes selecting, between the direct and the indirect interfaces, the interface having a smaller link latency.

4. The method of claim 1, wherein said selecting the handover execution interface includes selecting the direct interface when the link latency of the direct interface is equal to the link latency of the indirect interface.

5. The method of claim 1, further comprising: executing the handover through the selected interface.

6. The method of claim 1, further comprising: executing the handover through the indirect interface when no direct interface exists.

7. The method of claim 1, further comprising: executing the handover through the indirect interface when the direct interface has been selected as the handover execution interface and an error has occurred upon the execution of the handover through the selected direct interface.

8. The method of claim 1, further comprising: receiving the link latency of the direct interface and the link latency of the indirect interface, before said comparing a link latency of the direct interface with a link latency of an indirect interface indirectly connecting the source base station and the target base station.

9. The method of claim 1, wherein the direct interface is an X2 interface and the indirect interface is an S1 interface.

10. An apparatus for controlling a handover from a source base station to a target base station, the apparatus comprising:
a determination unit for determining whether a direct interface directly connecting the source base station and the target base station exists;
a comparison unit for comparing a link latency of the direct interface with a link latency of an indirect interface indirectly connecting the source base station and the target base station, when it is determined that the direct interface exists; and
a selection unit for selecting a handover execution interface, between the direct interface and the indirect interface, based on the comparison result.

11. The apparatus of claim 10, further comprising:
a direct interface manager for managing the direct interface; and
an indirect interface manager for managing the indirect interface.

12. The apparatus of claim 10, further comprising:
a direct interface link latency manager for receiving the link latency of the direct interface; and
an indirect interface link latency manager for receiving the link latency of the indirect interface.

13. The apparatus of claim 10, further comprising a handover execution unit for executing the handover through the selected interface.

14. The apparatus of claim 10, wherein the indirect interface is an interface which passes through a Mobility Management Entity (MME) and/or a Serving-GateWay (S-GW).

15. The apparatus of claim 10, wherein the selection unit selects the handover execution interface by selecting, between the direct and the indirect interfaces, the interface having a smaller link latency.

16. The apparatus of claim 10, wherein the selection unit selects the direct interface as the handover execution interface when the link latency of the direct interface is equal to the link latency of the indirect interface.

17. The apparatus of claim 13, wherein the handover execution unit executes the handover through the indirect interface when no direct interface exists.

18. The apparatus of claim 13, wherein the handover execution unit executes the handover through the indirect interface when the direct interface has been selected as the handover execution interface and an error has occurred upon the execution of the handover through the selected direct interface.

19. The apparatus of claim 10, wherein the direct interface is an X2 interface and the indirect interface is an S1 interface.
